(19) United States
(12) Patent Application Publication
(10) Pub. No.: US 2004/0151377 A1
(43) Pub. Date: Aug. 5, 2004

(54) Apparatus and methods for converting network drawings from raster format to vector format

(76) Inventors: Molly L. Boose, Bellevue, WA (US); David B. Shema, Seattle, WA (US)

Correspondence Address: HARNESS, DICKEY & PIERCE, P.L.C., P.O. BOX 828, BLOOMFIELD HILLS, MI, 48303, US

(21) Appl. No.: 10/357,847

(22) Filed: Feb. 4, 2003

(51) Int. Cl. G06K 9/46

(52) U.S. Cl. 382/193; 703/23

(57) ABSTRACT

Apparatus and methods for converting a network drawing from raster format to vector format. The method involves recognizing text within a raster image by using optical character recognition and a character set associated with the raster image. The recognized text is extracted from the raster image to produce a text-only raster image and a text-stripped raster image. The method further includes recognizing graphic objects within the text-stripped raster image by using pattern recognition with image-specific parameters to identify graphic objects. Recognized graphic objects are represented with vector graphical primitives to produce a text-stripped vector image. Vector text elements corresponding to the extracted text are added into the text-stripped vector image to produce a vector image that is substantially identical in appearance to the raster image.

### COPYRIGHT NOTICE

A portion of the disclosure of this document contains material that is subject to copyright protection. The copyright owner has no objection to the facsimile reproduction by anyone of the patent disclosure, as it appears in the U.S. Patent and Trademark Office patent files or records, but otherwise the copyright owner reserves all copyright rights whatsoever.

### FIELD OF THE INVENTION

The present invention relates to vectorization of raster images, and more particularly to apparatus and methods for converting network drawings from raster format to vector format.

### BACKGROUND OF THE INVENTION

Users of electronic technical drawings and schematics are increasingly demanding linking functionality comparable with that of electronic textual documents, wherein links between related pieces of information are common. As a result of the increasing demand, it is becoming more common for technical drawings to contain links that allow users to automatically link from an technical drawing to related graphical or textual information. Demand is also increasing for automatic understanding of technical content and its purpose in technical drawings. However, the difficulty in recognizing the many various graphical or logical constructs that may be contained in a technical drawing has prevented technical drawings from being provided with the same level of functionality as that associated with electronic text documents.

One approach to improving the functionality of technical and engineering drawings is through the use of vector drawings. With vector images, artwork is specified in a geometric sense, such as lines, circles, polygons, etc. and text is represented as text elements. Vector drawings also allow for embedded scripting, linking capability, among other explicit graphical and text entities. However, many existing technical drawings are not in vector format but instead comprise raster or bitmapped drawings, which are commonly produced by scanning paper copies of the technical drawings.

A raster image is a matrix or collection of pixels wherein each pixel displays a color. In a raster image, shapes are groupings of visible pixels whose color is different than the image's background color thus allowing the shape (e.g., circles, lines, arcs, etc.) to be visible to a user.

For decades, raster images have had very limited functionality in electronic systems because such systems have been unable to understand the content of raster images, which do not provide high-level structures such as text records or graphical primitives. Although text recognition in raster images has been successfully achieved by using existing optical character recognition (OCR) systems and image processing techniques, such systems and techniques have difficulty in accurately and completely finding higher-level objects such as lines, circles, arcs, polygons, etc.

Today, relatively expensive and time-consuming methods are now being used to make raster images more useful in electronic systems. One exemplary approach is to manually re-author raster images into vector format. However, the process involved with manually re-authoring even a single raster image typically requires many hours. Considering the multitude of existing technical drawings for which it would be desirable to convert to vector format, manually re-authoring so many raster images is not practical.

Another common method is to manually create a companion graphic that contains hyperlink and hotspot information for the original raster image. However, using the best authoring tools currently available, this process requires many hours per image. Moreover, there is no known automated solution for creating companion graphics containing hyperlink and hotspot information for raster images.

Although commercially available raster-to-vector conversion computer software programs exist and have been successful for their intended purposes, it would be highly desirable to provide an automated solution that more accurately and more completely converts raster technical images to vector format.

### SUMMARY OF THE INVENTION

Accordingly, the inventors have recognized that a need exists in the art for devices and methods for converting network drawings from raster format to vector format in a highly accurate, complete, efficient, and automated batch process that requires little to no user intervention.

The present invention is directed to a system and method for converting a network drawing from raster format to vector format. The method generally involves recognizing text within a raster image by using optical character recognition and a character set associated with the raster image. The recognized text is extracted from the raster image to produce a text-only raster image and a text-stripped raster image. The method further includes recognizing graphic objects within the text-stripped raster image by using pattern recognition with image-specific parameters to identify graphic objects. Recognized graphic objects are represented with vector graphical primitives to produce a text-stripped vector image. Vector text elements corresponding to the extracted text are added into the text-stripped vector image to produce a vector image that is substantially identical in appearance to the raster image.

Further areas of applicability of the present invention will become apparent from the detailed description provided hereinafter. It should be understood that the detailed description and specific examples, while indicating at least one preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a simplified block diagram of a system in accordance with a preferred embodiment of the present invention;

FIG. 2 is an exemplary raster wiring image that may be provided as input to the system shown in FIG. 1;

FIG. 3 is a flowchart of the steps performed during a method for converting a network drawing from raster format to vector format in accordance with a preferred embodiment of the present invention;

FIG. 4 is a text-only raster image produced by system shown in FIG. 1 while converting the raster wiring image shown in FIG. 2;

FIG. 5 is a text-stripped raster image produced by the system shown in FIG. 1 while converting the raster wiring image shown in FIG. 2;

FIG. 6 is an exemplary raster image fragment in which six binary large objects have been identified, wherein each binary large object (BLOB) will be transformed by the system shown in FIG. 1 from a pixel grouping into a corresponding vector object;

FIG. 7 is an illustration of an exemplary pixel run;

FIG. 8A is an illustration of fifteen (15) pixel runs that can be merged to form the single two-dimensional pixel run shown in FIG. 8B;

FIG. 8B is an illustration of the single two-dimensional pixel run formed from the merger of the fifteen (15) pixel runs shown in FIG. 8A;

FIG. 9 is an illustration of a collection of eleven pixel runs forming an exemplary oblique line;

FIG. 10 is an illustration of the horizontal, vertical and oblique lines discovered by the system shown in FIG. 1 while performing an initial line recognition step on the text-stripped raster image shown in FIG. 5;

FIGS. 11A, 11B, 11C, and 11D are illustration of various stages of a binary large object repair process performed by the system shown in FIG. 1;

FIG. 12 is an illustration of various binary large objects recognized by the system shown in FIG. 1 while performing a binary large object recognition step on the text-stripped raster image shown in FIG. 5;

FIG. 13 is an illustration of four “noisy” pixel runs that can be ignored during recognition of the horizontal line;

FIGS. 14A, 14B and 14C, respectively, are illustrations of an exemplary hollow triangle in raster format, in vector format, and the vector triangle overlaying the raster triangle;

FIGS. 15A and 15B, respectively, are illustrations of an exemplary solid circle in raster format and in vector format;

FIG. 16 is a text-stripped vector image produced by the system shown in FIG. 1 from the text-stripped raster image shown in FIG. 5; and

FIG. 17 is a vector image produced by the system shown in FIG. 1 from the raster wiring image shown in FIG. 2.

Corresponding reference characters indicate corresponding features throughout the drawings.

### DETAILED DESCRIPTION OF THE PREFERRED EMBODIMENTS

The following description of the preferred embodiment(s) is merely exemplary in nature and is in no way intended to limit the invention, its application, or uses.

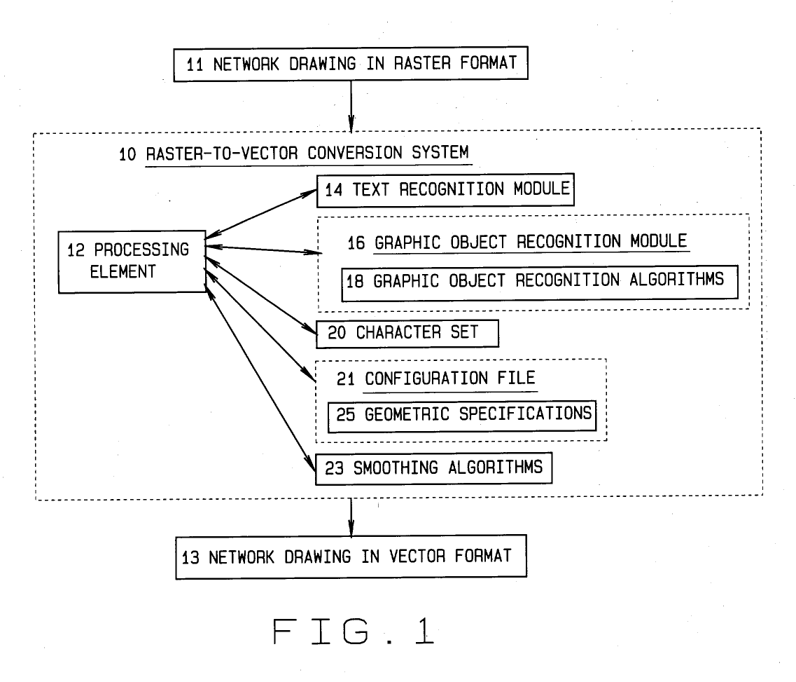

Referring to FIG. 1, there is shown a system 10 in accordance with a preferred embodiment of the present invention. Generally, the system 10 converts network drawings 11 from raster format to vector format 13 in a substantially automated batch process during which the system 10 accesses data specific to the particular type of network drawing being converted. The system 10 converts the network drawings from raster format to vector format by accessing image-specific parameters including a specially built character set 20 to recognize text and geometric specifications 25 to recognize graphic objects. Upon completion of the raster-to-vector conversion, the usability of the information in the original raster image is dramatically improved in that the vectorized network drawing is suitable for intelligent graphics processing, which provides advanced and efficient user interaction, electronic linking, signal path tracing, electronic simulations, text searching, database integration, automatic zooming and panning, among other functional capabilities. As used herein, the term “network drawing” refers to and includes drawings depicting various symbols organized and interconnected by lines (e.g., horizontal, vertical, oblique) accordingly to show the relationship between the symbols. By way of example only, the network drawings include, but are not limited to, wiring diagrams, schematics, logic flow diagrams, blue prints, etc.

As shown in FIG. 1, the system 10 includes a suitable processing element 12 for performing the various operations during the raster-to-vector conversion. The processing element 12 is typically comprised of a combination of hardware (e.g., one or more microprocessors, other processing devices) and software that is stored by memory and executed by the hardware. In the illustrated embodiment, the processor 12 executes a text recognition program or software module 14, a graphic object recognition program or software module 16, graphic object recognition algorithms 18, and smoothing algorithms 23. However, it should be understood that the processing element 12 can be comprised of other combinations of hardware, software, firmware or the like so long as the resulting combination is capable of implementing the various operations required for the raster-to-vector conversion, each of which are described in greater detail below.

The system 10 also includes memory which may take the form of any suitable computer readable storage device. For example, the memory may comprise read only memory (ROM), random access memory (RAM), video memory (VRAM), hard disk, floppy diskette, compact disc (CD), an optical disk, magnetic tape, a combination thereof, etc. The memory may comprise computer readable media for storing such items as program code, software packages, programs, algorithms, information, data, files, databases, applications, among other things.

In the embodiment shown in FIG. 1, the system 10 includes the text and graphic object recognition modules 14 and 16 that are executable by the processing element 12. The graphic object recognition module 16 includes a plurality of graphic object recognition algorithms 18 (e.g., horizontal line recognition algorithm, vertical line recognition algorithm, oblique line recognition algorithm, binary large object (BLOB) recognition algorithm, solid circle recognition algorithm, hollow triangle recognition algorithm, arc recognition algorithm, among others). Each algorithm 18 recognizes a specific type of object or graphical construct that is made up of one or more known graphical primitives. Altogether, the algorithms 18 are tailored to search for the various graphic objects and specific content that may be contained in a network drawing. The text and graphic object recognition modules 14 and 16, the graphic object recognition algorithms 18, and the smoothing algorithms 23 may be embodied in computer-readable program code stored in one or more computer-readable storage media operatively associated with the system 10.

It is to be understood, however, that the computer readable program code described herein can be conventionally programmed using any of a wide range of suitable computer readable programming languages that are now known in the art or that may be developed in the future. It is also to be understood that the computer readable program code described herein can include one or more functions, routines, subfunctions, and subroutines, and need not be combined in a single package but may instead be embodied in separate components. In addition, the computer readable program code may be a stand-alone application, or may be a plug-in module for an existing application and/or operating system. Alternatively, the computer readable program code may be integrated into an application or operating system. In yet another embodiment, the computer readable program code may reside at one or more network devices (not shown), such as an administrator terminal, a server, etc.

Although the present invention is described with the text and graphic object recognition modules 14 and 16, graphic object recognition algorithms 18 and the smoothing algorithms 23 having a direct effect on and direct control of the system 10, it should be understood that it is the instructions generated by the execution of the programs 14, 16, 18, and 23 by the processing element 12, and the subsequent implementation of such instructions by the processing element 12, that have direct effect on and direct control of the system 10.

The system 10 further includes image-specific information for the set of network drawings being vectorized, which is accessed during the execution of the text and graphic object recognition modules 14 and 16, respectively. As shown, the system 10 includes the specially built textual character set 20 that is accessed by the processing element 12 during text recognition. Because raster images of network drawings can vary significantly depending on the authoring or scanning system that was used to generate the raster images, the system 10 also includes the configuration file 21. The configuration file 21 contains geometric specifications 25, domain specific constraints, data and other information about the specific set of raster images such as the approximate size of the raster images, the approximate sizes of certain objects (e.g. circles or lines), the relative locations of certain objects, among other data.

With further reference to FIG. 1, the system 10 also includes one or more noise smoothing algorithms 23. The noise smoothing algorithms 23 are used throughout the graphic object recognition process 50 to determine which pixels in the raster image are noise and thus can be ignored without losing any information.

During operation, the system 10 performs many iterations during the translation from raster to vector format. With each iteration, more of the raster image is translated by the system 10 to vector format and no longer needs to be analyzed by the system 10.

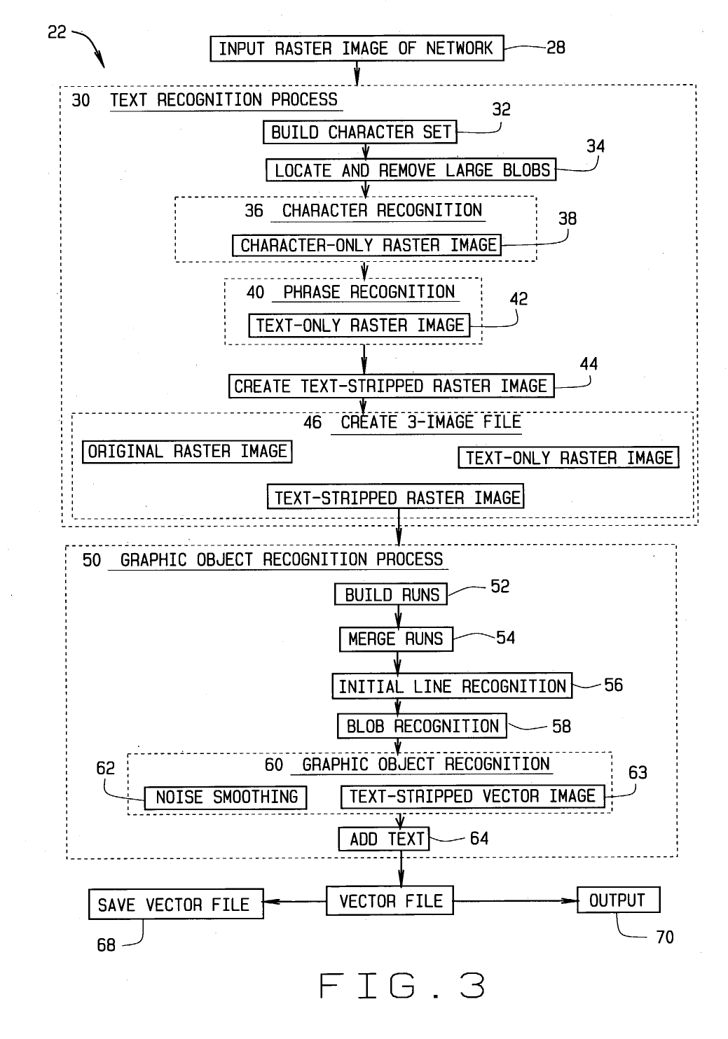

Referring now to FIG. 3, a preferred method 22 implemented by the system 10 is illustrated in simplified flow chart form. As shown, step 28 comprises inputting the raster network image 11 (i.e., the network drawing in raster format) into the system 10.

After the raster image 11 has been inputted, the system 10 executes the text recognition module 14 and performs a text recognition process 30 on the raster image 11. The text recognition process 30 generally comprises using the character set 20, image processing and optical character recognition (OCR) to scan the raster image 11 for textual characters (e.g., alphanumeric characters, etc.) and certain technical and mathematical notations such as “±” and “Ω.” In an preferred embodiment, system 10 executes Cartouche® OCR computer software from RAF Technology, Inc. of Redmond, Wash. during the text recognition process 30.

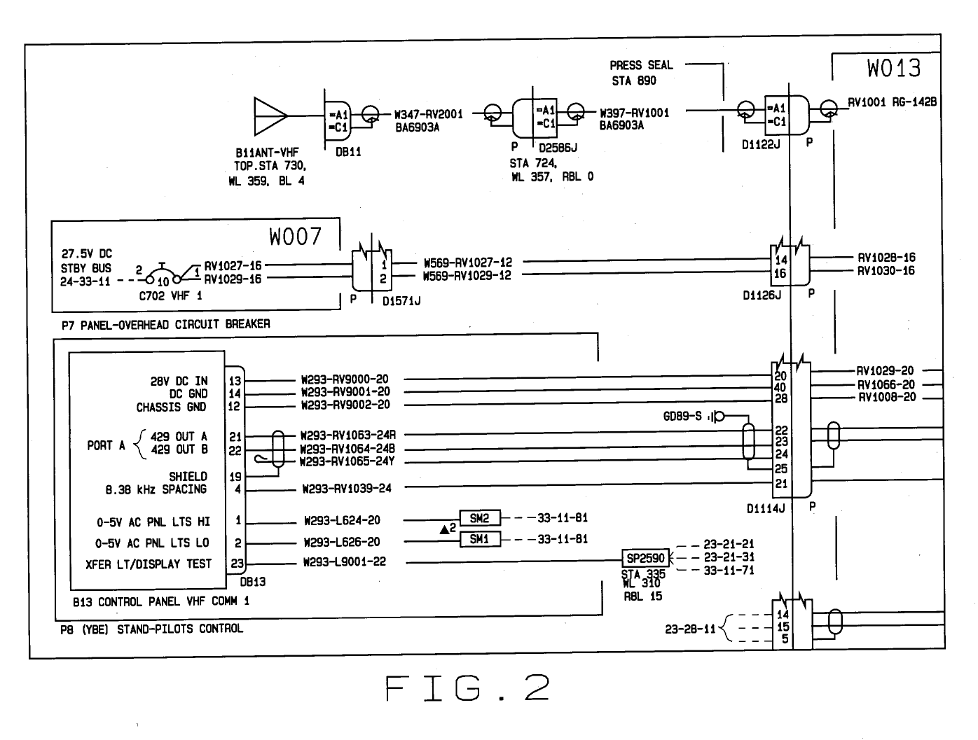

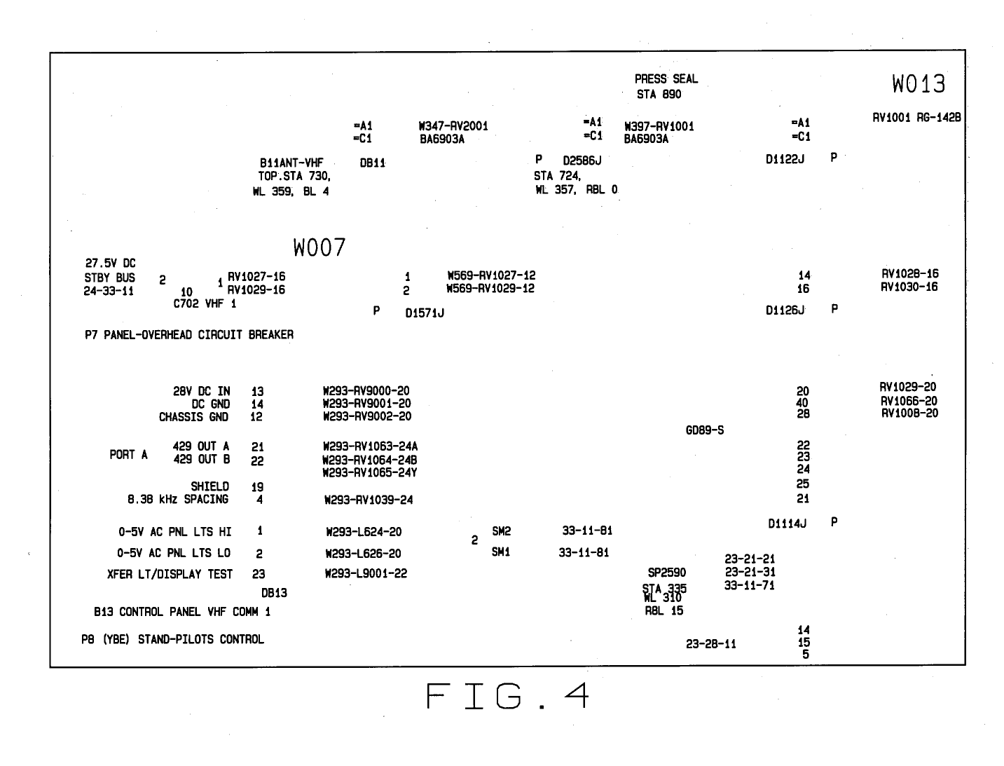

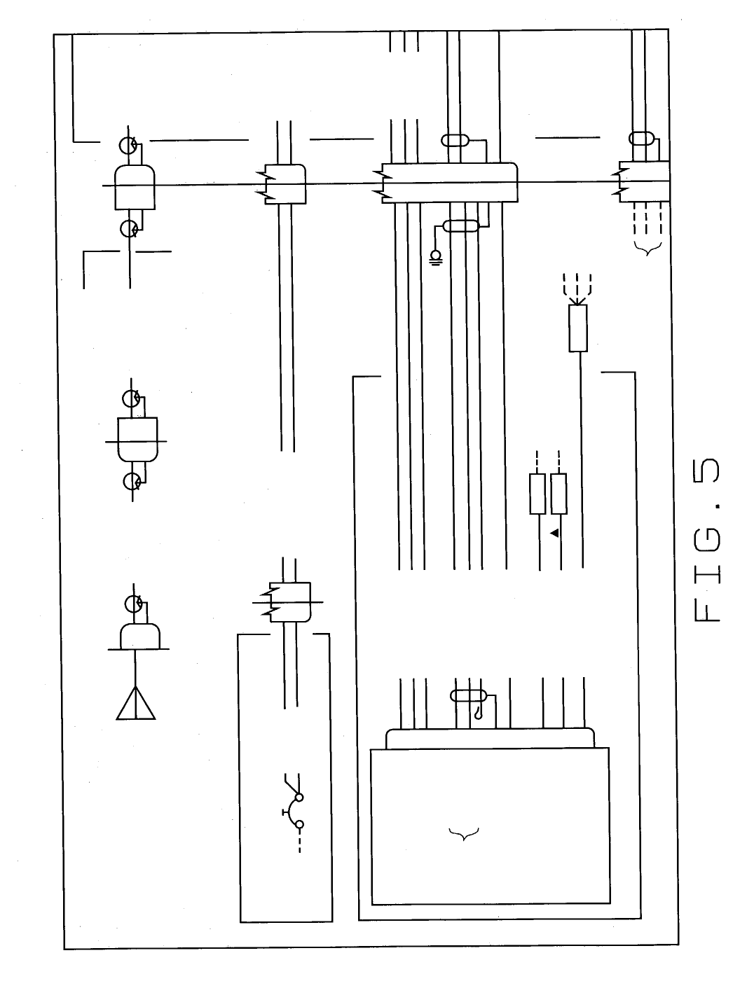

Once found, the textual characters are appropriately concatenated to form words and phrases. The textual information is then extracted to produce a text-only raster image and a text-stripped raster image. More specifically, the textual information is stored separately from the original raster image 11 to produce a first raster image containing only the textual characters (e.g., letters, words, phrases, numbers, diagrammatic notations, etc.). The pixels that formed the textual characters are then effectively erased from the original raster image 11 to produce a second raster image containing everything in the original raster image except the text. Accordingly, the first and second raster images are referred to herein as the “text-only raster image” and the “text-stripped raster image”, respectively, for ease of identification and description and not for purposes of limitation. FIGS. 4 and 5 show exemplary text-only and text-stripped raster images, respectively, that are produced by the system 10 while converting the raster wiring image shown in FIG. 2 to vector format.

Referring back to FIG. 3, the text recognition process 30 of the preferred method 22 comprises the following steps. At step 32, the specialized character set 20 (FIG. 1) is built for the particular set of raster image(s) being converted. If more than one unique set of raster images are being converted, it may be necessary to build a specialized character set for each unique set of images depending on their content. The content may, for example, vary based upon the type of network drawings and the imaging and/or authoring system that was used to produce the original raster images.

At step 34 (FIG. 3), the system 10 locates binary large objects or blobs on the raster image 11 that are too large to be characters so that the large blobs may be ignored during the text recognition process 30. Ignoring the large blobs during the text recognition process 30 substantially improves the processing speed and accuracy of the system 10 during the text recognition process 30. As used herein, a “binary large object” or “blob” refers to and includes a grouping of all visible pixels that are joined or connected, either horizontally, vertically or diagonally, to one or more other visible pixels in the grouping. A visible pixel is a pixel whose color is different than that of the background color of the image. In FIG. 6, there is shown an illustration of an exemplary raster image fragment in which six binary large objects have been identified. It should be noted, however, that a typical network drawing in raster format may include thousands of binary large objects.

With further reference to FIG. 3, step 36 comprises character recognition during which the system 10 runs a character recognition engine on the remaining “small” blobs (i.e., those blobs that were not removed at step 34). During step 36, the system 10 accesses the data within the character set 20 to determine whether a blob is a character. For each blob, a confidence number is returned indicating how well the blob matches an entry in the character set 20. Each blob having a sufficiently high enough confidence number is then copied onto a blank image, thus creating a character-only image 38.

Step 40 comprises phrase recognition during which the system 10 runs a phrase recognition engine on the character-only image 38 to generate a text-only raster image 42, such as the exemplary text-only raster image shown in FIG. 4. During step 40, the system 10 groups the characters recognized at step 36 into word and phrase entities and then creates bounding boxes surrounding the word and phrase entities. The bounding boxes provide location and size information for the word and phrase entities.

At step 44, a text-stripped raster image is created by scrubbing or erasing from the raster image 11 the pixels within the bounding boxes (i.e., the pixels forming the words and phrase entities recognized at step 40). FIG. 5 shows an exemplary text-stripped image produced by the system 10 while converting the exemplary-raster wiring image shown in FIG. 2 to vector format. A comparison of FIGS. 2 and 5 demonstrates how removing the text first greatly simplifies the difficulty associated with finding graphical primitives in a raster image.

At step 46 (FIG. 3), the original raster image, the text-stripped raster image, and the text-only raster image are saved in a single file. Accordingly, there will be one such file for every raster image being converted to vector format by the system 10.

Upon completion of the text recognition process 30, the system 10 executes the graphic object recognition module 16 and performs a graphic object recognition process 50. The input for the graphic object recognition process 50 comprises the text-stripped raster image produced during the text recognition process 30.

During the graphic object recognition process 50, the system 10 preferably executes the graphic object recognition algorithms 18 (FIG. 1) in an order such that the simpler or less ambiguous graphic objects (graphic objects that are less likely to be misidentified) (e.g., long horizontal or vertical lines, etc.) are recognized in the text-stripped raster image before the increasingly complex or more ambiguous graphic objects (e.g., very short oblique lines, very small arcs, etc.) are recognized. The system 10 stores the vector graphical primitives of the less ambiguous graphic objects and eliminates their pixels from further processing before the system 10 recognizes the increasingly complex or more ambiguous graphic objects.

As graphic objects are recognized and their vector graphical primitives stored, the text-stripped raster image will increasingly have less pixels requiring analysis. Therefore, finding the less ambiguous graphic objects first and eliminating their pixels makes it far less likely that errors will occur when identifying the more ambiguous graphic objects in the text-stripped raster image.

The corresponding graphic object recognition algorithms for identifying the less ambiguous graphic objects have highly constrained pattern-matching rules. Conversely, the more ambiguous graphic objects are identified by graphic object recognition algorithms that have less constrained pattern-matching rules. For example, a blob forming a solid circle may be found with an algorithm that has many rules including: (1) the blob must have a square bounding box, (2) there can be no holes in the blob (the pixel runs, Which are described in detail below, must each touch the edge of the circle), (3) beginning from the top of the blob, the pixel runs must increase in length until the circle middle is reached at which point the pixel runs must decrease until the bottom of the circle is reached, and (4) the horizontal midpoint of each pixel run must be very close to the x-value of the circle's center. Thus, solid circles are one of the less ambiguous graphic objects to identify, whereas arcs can be very ambiguous and accordingly are recognized much later than solid circles.

The graphic object recognition algorithms 18 access the image-specific parameters (e.g., geometric specifications 25) within the configuration file 21, as necessary, to accurately identify a blob as a match. As different sets of network drawings are processed, the configuration file 21 will change and may even require the addition of new and different parameters therein.

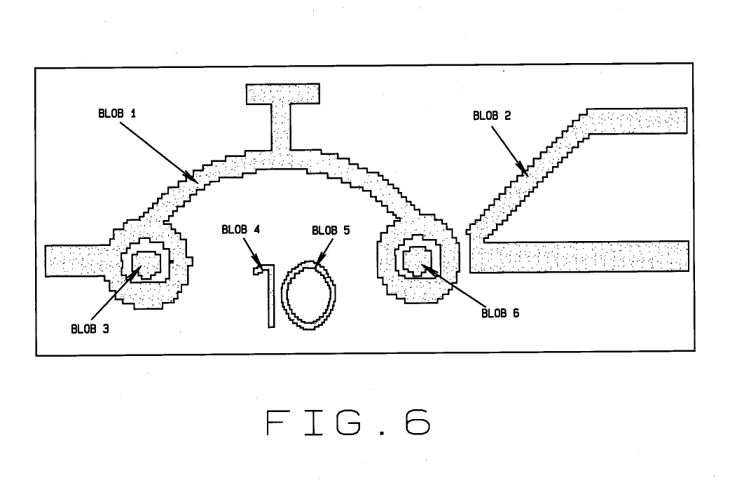

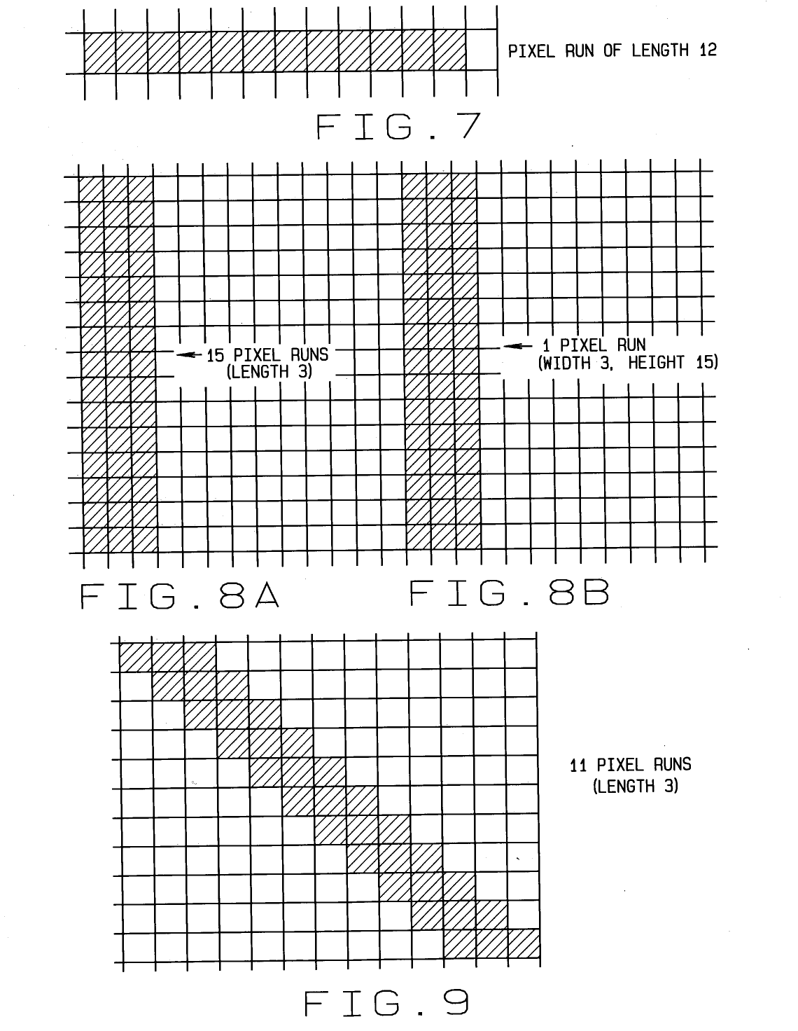

In the preferred method 22 shown in FIG. 3, the graphic object recognition process 50 comprises the following steps. At step 52, the system 10 builds a list of pixel “runs” from the text-stripped raster image within the three-image file created at step 46. As used herein, a “pixel run” is a grouping of pixels that are adjacent horizontally and share the same y-coordinate, as shown in FIG. 7. The initial runs built at step 52 each have a height of one (1) pixel but may have varying lengths or widths depending on how many adjacent pixels are found. A typical network drawing in raster format may include tens of thousands of pixel runs.

At step 54, the pixel runs having identical x-coordinates and adjacent y-coordinates are merged to create two-dimensional pixel runs. This step improves performance by significantly reducing the number of pixel runs that must be analyzed by the graphic object recognition software. A typical raster wiring image may start with one hundred thousand (100,000) pixel runs. The pixel run merging process will typically reduce the number of pixel runs by sixty percent (60%) or more. Merging pixel runs also simplifies the coding of the graphic object recognition algorithms 18. When a pixel run is merged with another run it is removed from the list of runs. The remaining run is modified so that it is now “thicker” or “taller” than it was before the merge (i.e., it is now a two-dimensional pixel run). For example, FIG. 8A shows fifteen (15) pixel runs, each having a width or length of three (3) pixels and height of one (1) pixel, that can be merged to form the single two-dimensional pixel run having a width of three (3) pixels and a height of fifteen (15) pixels, which is shown in FIG. 8B.

Step 56 (FIG. 3) comprises initial line recognition during which the system 10 performs an iterative process over the list of pixel runs to locate pixel runs having a relatively large width or height. If a pixel run is located that is relatively tall (i.e., has a large height) and narrow (i.e., has a very small width), the system 10 creates a vertical line for the pixel run and the pixel run is eliminated from the run list. For example, the merged run shown in FIG. 8B can be eliminated from the run list after a corresponding vertical line is created with a height of fifteen (15) pixels and a line thickness of three (3) pixels. If a pixel run is relatively wide and not too tall, a horizontal line can be created for the pixel run and it can be eliminated from the run list. Horizontal lines are merged runs whose widths exceed their heights while meeting a minimum length requirement, whereas vertical lines are merged runs whose heights exceed their widths while meeting a minimum length requirement.

It should be noted that the resolution for the raster images being vectorized may vary depending on the particular application in which the present invention is being used. Likewise, the determination of when a pixel run should be substituted with a horizontal or vertical line will also vary depending on the particular application in which the present invention is being used. By way of example only, a long horizontal line might be required to be at least five to ten percent (5-10%) of the width of the entire image.

For oblique lines, the oblique line recognition algorithm considers runs with very small widths and heights. More specifically, the oblique line recognition algorithm begins looking for adjacent runs in the y-direction that are very close to the same length and that are shifted to the left or to the right by a small amount. The oblique line recognition algorithm continues looking for the next pixel run that is adjacent in the y-direction to the last pixel run found and that is shifted by the same small amount in the same direction. This process of adding pixel runs to the collection is continued as long as the lengths of the pixel runs continue to be very close and the shift direction and shift size continue to be consistent. When the system 10 cannot find another pixel run to add to the run collection, a determination is made as to whether the resulting oblique line is sufficiently long to allow for the creation of an oblique line and removal of the run collection from the run list. FIG. 9 shows an exemplary collection of eleven (11) pixel runs of length three (3) pixels (width=3, height=1) that form an oblique line. As just described, the eleven pixel runs are removed from the list of runs after an oblique line is created for the eleven pixel runs.

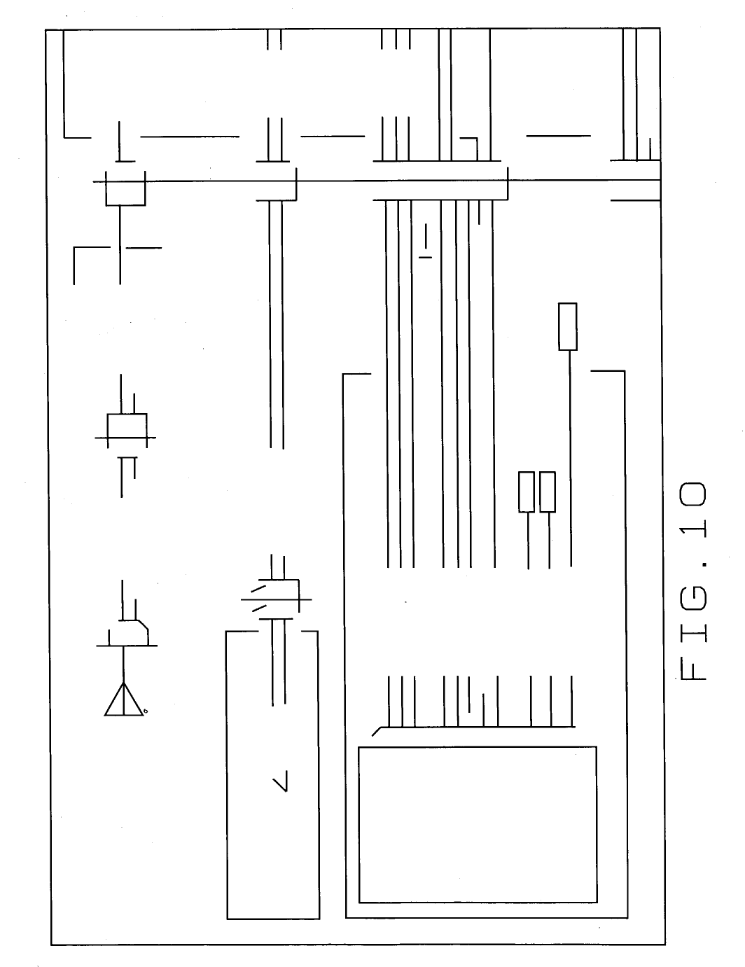

It should be noted that the dimensional requirements for each type of line (e.g., horizontal, vertical, oblique, etc.) are specified in the configuration file 21 and can be changed for different sets of raster images. FIG. 10 shows the horizontal, vertical and oblique lines that were discovered during the initial line recognition step 56 performed by the system 10 on the text-stripped raster image shown in FIG. 5.

Referring back to FIG. 3, step 58 comprises blob recognition wherein the system 10 locates and then stores blobs. At step 58, the system 10 iterates over the remaining pixel runs in the pixel run list (i.e., the pixel runs not eliminated during the initial line recognition step 56) to find and group the pixel runs that are overlapping in the horizontal, vertical or diagonal direction. Step 58 comprises creating a blob with the first pixel run in the pixel run list and then adding the pixel runs that are connected to any pixel runs already in the blob. Pixel runs, which are added to the blob, are removed from the pixel run list. Accordingly, the blob continues to grow until no more connecting pixel runs are found. A new blob is then started with the pixel run now first in the pixel run list. The new blob is grown until no more connecting pixel runs can be found for the new blob. The process of creating blobs with the first pixel run in the pixel run list and then growing the blobs continues until every unused pixel run is put into a blob.

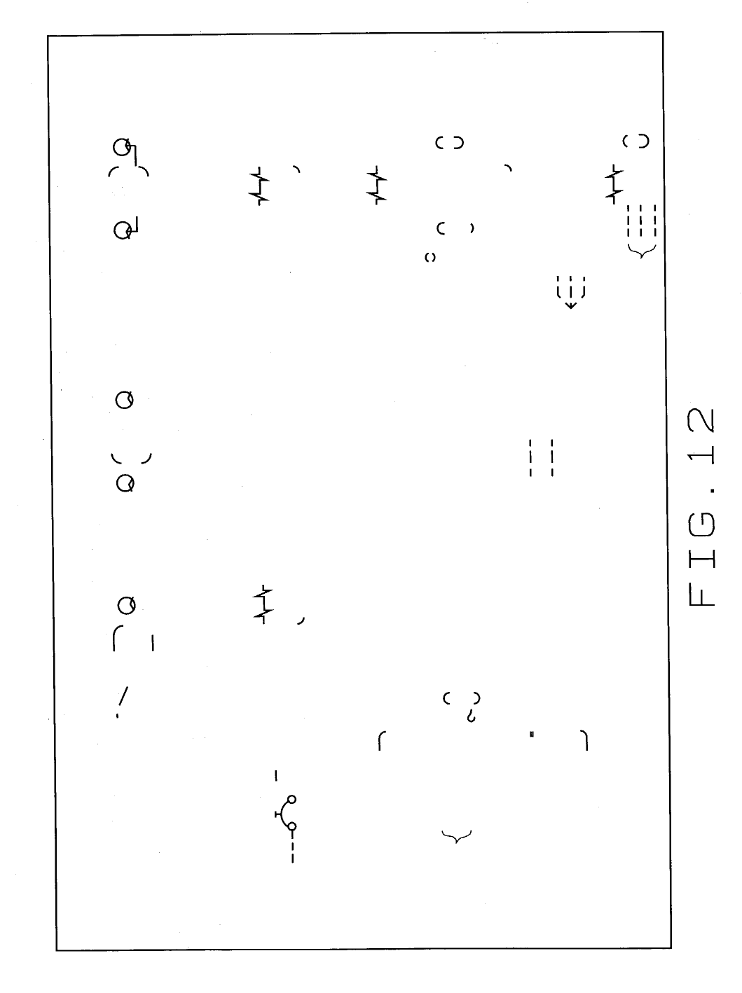

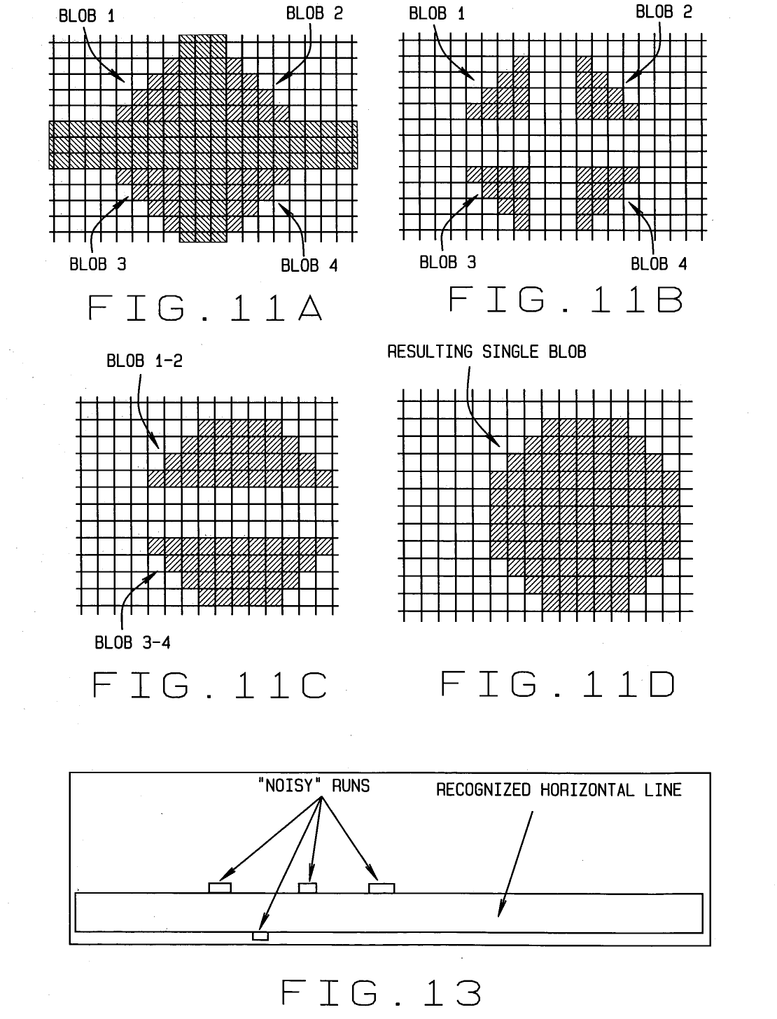

The pixel removal during the initial line recognition step 56 may have caused one or more blobs to be split up into several blobs. To merge a split blob back into a single blob, the blob recognition algorithm recovers the pixels removed during the initial line recognition step 56 that caused the blob to split. FIG. 11A, 11B, 11C, and 11D illustrate various stages of a blob repair process. More specifically, FIG. 11A shows a gray-patterned area of pixels that must be recovered to merge the four blob portions back into a single blob. FIG. 11C shows the merger of the upper blob portions and the merger of the lower blob portions. FIG. 11D shows the completely merged blob when the horizontal line's pixels are restored.

Upon completion of the blob recognition step 58, a set of blobs exists that can be recognized by the graphic object recognition algorithms 18 and successfully translated into vector graphical primitives by the system 10. FIG. 12 shows the numerous blobs recognized by the system 10 during the blob recognition step 58 for the text-stripped raster image shown in FIG. 5.

Step 60 (FIG. 3) comprises graphic object recognition during which the system 10 executes the various graphic object recognition algorithms 18 over the list of blobs recognized at step 58 and matches the blobs to their corresponding graphic object. As previously described, the algorithms 18 are preferably run in an order from the most constrained to the least constrained such that the less ambiguous graphic objects are recognized before the more ambiguous graphic objects.

When an object match for a blob is found, the appropriate vector graphical primitive(s) is stored and the blob is removed from the list of blobs. After all of the graphic object recognition algorithms 18 have been run, the pixels forming each blob will have been replaced by the appropriate vector graphical primitive(s).

Throughout the graphic object recognition step 60, noise smoothing (step 62) is preferably performed via the system's 10 execution of the noise smoothing algorithms 23 (FIG. 1). The noise smoothing step 62 determines when a pixel run is “noise” and thus can be ignored without losing any information. At step 62, the smoothing is performed over relatively small areas of the text-stripped raster image. For example, the system 10, while running an arc recognition algorithm, will consider a number of (i.e., one or more) pixel runs to be noise when a relatively low ratio exists between the number of pixels forming the suspected noisy pixel runs to the total number of pixels making up the blob suspected of being an arc. However, if the ratio is too high then the blob will not be identified as an arc. FIG. 13 shows four “noisy” pixel runs that can be removed during recognition of a horizontal line without losing any information.

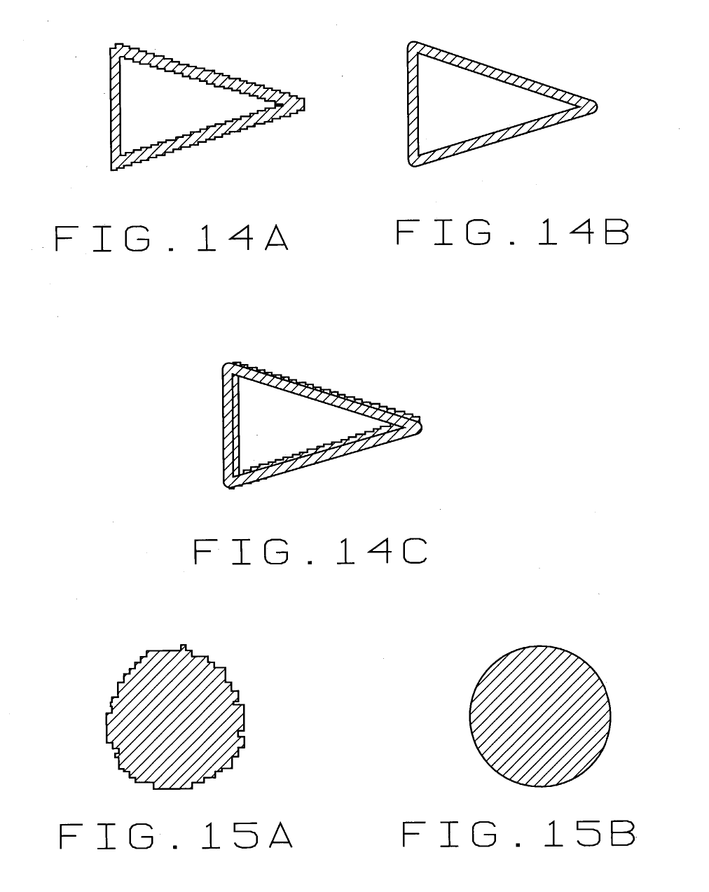

Referring now to FIG. 14, there is shown an exemplary hollow three-point polygon (i.e., a triangle) in raster format (FIG. 14A) and in vector format (FIG. 14B). FIG. 14C shows an overlay of the raster triangle with the converted vector graphical primitive (i.e., a 3 point polygon). As shown, the raster triangle is represented by 291 pixels and is encoded using 88 pixel runs, whereas the vector triangle is represented with a single graphical primitive, i.e., a 3-point polygon.

FIG. 15 shows an exemplary solid circle in raster format (FIG. 15A) and in vector format (FIG. 15B). As shown, the raster circle is represented by 512 pixels and is encoded using 30 pixel runs, whereas the vector circle is represented with a single graphical primitive, i.e., a circle.

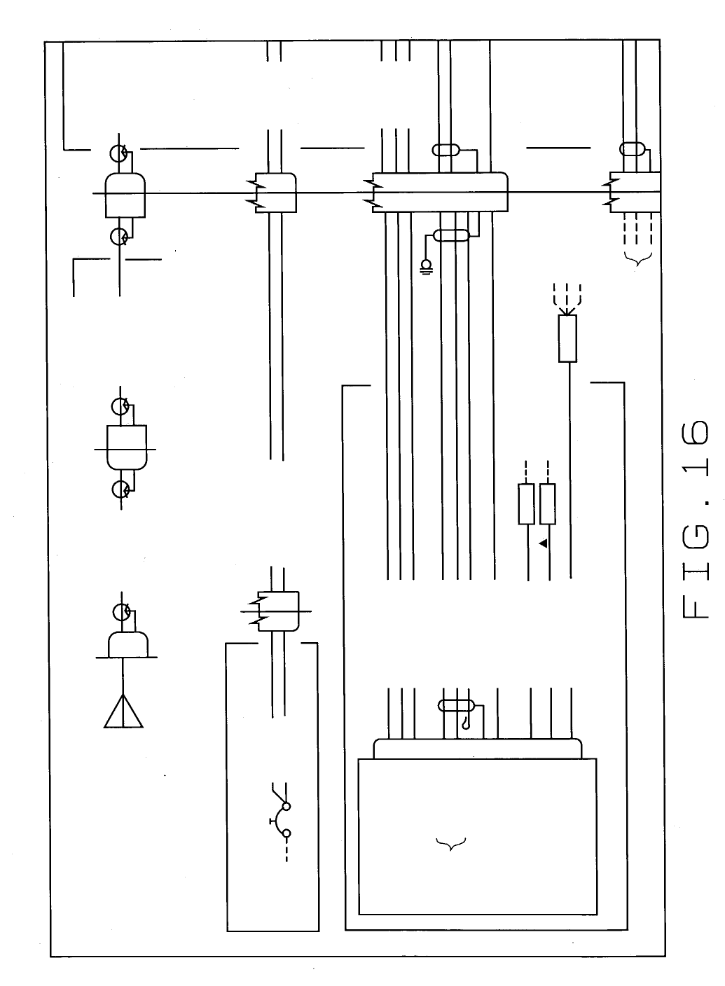

Upon completion of the graphic object recognition step 60 (FIG. 3), each of the vector graphical primitives that correspond to the recognized blobs are included in a text-stripped vector image 63. An exemplary text-stripped vector image is shown in FIG. 16. Although the text-stripped images shown in FIGS. 5 and 16, respectively, appear substantially identical, the underlying representations are vastly different in that FIG. 5 is encoded with pixels whereas FIG. 16 is encoded with vector graphical primitives.

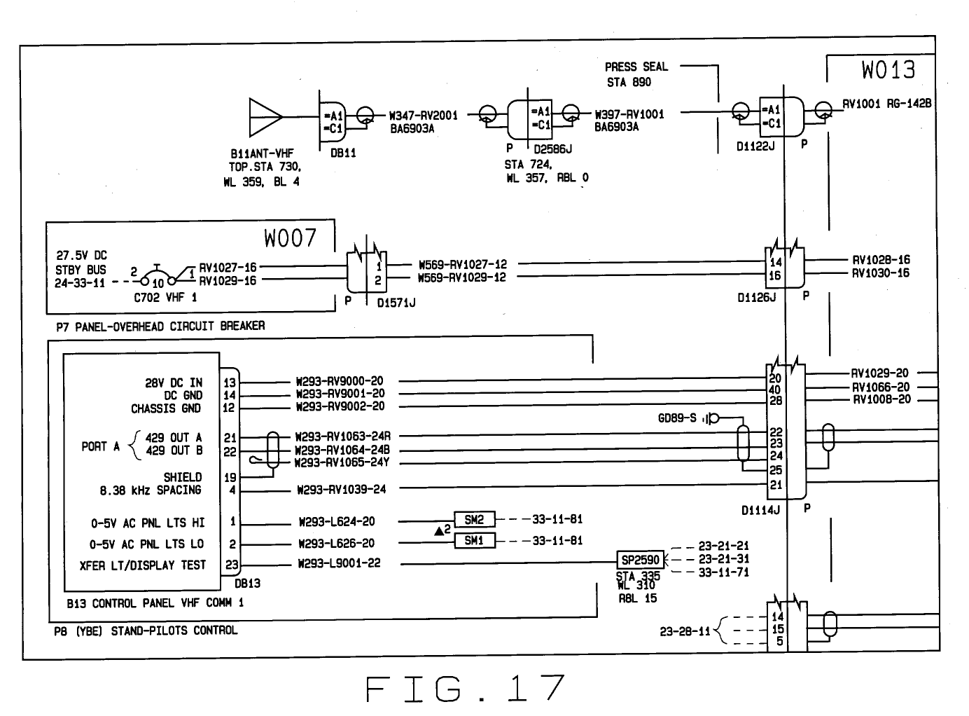

At step 64 (FIG. 3), the system 10 reintroduces or adds as vector text elements the text found and stripped from the original raster image during the text recognition process 30 into the text-stripped vector image 63, thus creating a vector file. The vector file contains the text identified during the text recognition process 30 and the graphical primitives identified during the graphic object recognition process 50. FIG. 17 shows an exemplary vector image that may be contained within a vector file produced by the system 10 while converting the exemplary raster wiring image shown in FIG. 2. As evident from a comparison of FIGS. 2 and 17, the vector image (FIG. 17) is substantially identical in appearance to the raster image (FIG. 2). However, the underlying representations are vastly different in that FIG. 2 is encoded with pixels, whereas FIG. 17 is encoded with vector text elements and vector graphical primitives.

By way of example, the vector files produced by the system 10 may be encoded in a file format called Computer Graphic Metafile (CGM), a widely-used technical illustration format file. Alternatively, however, other languages and file formats may also be used to encode the vector files produced by the system 10 including, but not limited to, DWG format, document exchange format (DXF) and initial graphics exchange specification (IGES) format.

Upon completion of the graphic object recognition process 50, the vector file may be saved on a suitable computer readable medium at step 68, as shown in FIG. 3. Alternatively, or additionally, the vector file may be output at step 70, for example, to a graphical display.

The system 10 preferably comprises a batch conversion processor such that the raster-to-vector conversion process requires minimal human intervention and no manual re-authoring of the raster images. Accordingly, the present invention provides a more practical and cost-effective solution for converting network drawings from raster format to vector format than that presently recognized in the art.

By more accurately, completely and efficiently converting network diagrams and schematics from raster format to vector format, the present invention dramatically improves the usability of the information in the network drawings. After being converted to vector format in accordance with the present invention, the network drawing is suitable for intelligent graphics processing that enables advanced and efficient user interaction, electronic linking, signal path tracing, electronic simulations, automatic zooming and panning, among other functional capabilities, etc.

Moreover, the present invention also enables automatic text searching in network drawings that is comparable to the automatic text searching capabilities associated with HTML (hypertext markup language) documents. Enabling automatic text searching in network drawings allows for substantial time reductions to be realized in the performance of troubleshooting tasks.

The present invention also eliminates, or at least reduces, the need for storing and delivering paper-based network drawings in that paper-based network drawings can be scanned to create raster images thereof, which are then efficiently converted by the present invention to vector format. Additionally, the present invention also allows for significant reductions in maintenance costs because authors, illustrators and maintainers will not have to maintain raster data after its conversion to vector format. Moreover, converting network drawings from raster format to vector format will reduce costs of electronic drawing deliveries because vector graphics require less computer storage space than the pixel matrices of raster images.

It is anticipated that the invention will be applicable to any of a wide range of network drawings including, but not limited to, wiring diagrams, schematics, logic flow diagrams, blue prints, etc. Accordingly, the specific references to raster wiring images and wiring diagrams herein should not be construed as limiting the scope of the present invention, as the invention could be applied to convert network drawings from raster format to vector format regardless of whether the network drawings include wiring or non-wiring data.

The description of the invention is merely exemplary in nature and, thus, variations that do not depart from the substance of the invention are intended to be within the scope of the invention. Such variations are not to be regarded as a departure from the spirit and scope of the invention.

What is claimed is:

1. A method for converting network drawings from raster format to vector format, the method comprising:
recognizing text within a raster image by using optical character recognition and a character set associated with the raster image, the raster image comprising a network drawing in raster format;
extracting the recognized text to produce a text-only raster image and a text-stripped raster image;
recognizing graphic objects within the text-stripped raster image by using pattern recognition and image-specific parameters associated with the raster image,
using vector graphical primitives corresponding to the recognized graphic objects to produce a text-stripped vector image; and
adding vector text elements corresponding to the extracted text into the text-stripped vector image to produce a vector image substantially identical in appearance to the raster image.

2. The method of claim 1, wherein recognizing graphic objects within the text-stripped raster image comprises recognizing less ambiguous graphic objects before recognizing more ambiguous graphic objects.

3. The method of claim 1, wherein recognizing graphic objects within the text-stripped raster image comprises noise smoothing.

4. The method of claim 1, wherein recognizing graphic objects within the text-stripped raster image comprises:
building a list of two-dimensional pixel runs;
recognizing lines from the list of two-dimensional pixel runs;
removing from the list of two-dimensional pixel runs the pixel runs recognized as lines;
recognizing binary large objects from the list of two-dimensional pixel runs; and
recognizing graphic objects from the recognized binary large objects by matching each binary large object with its corresponding vector graphical primitive.

5. The method of claim 4, wherein building a list of two-dimensional pixel runs comprises:
merging pixel runs having identical x-coordinates and adjacent y-coordinates to create two-dimensional pixel runs; and
removing the pixel runs merged with another pixel run from the list of two-dimensional pixel runs.

6. The method of claim 4, further comprising repairing binary large objects split by pixel removal during line recognition.

7. The method of claim 1, further comprising defining the image-specific parameters.

8. The method of claim 1, wherein the raster image comprises a wiring diagram in raster format.

9. A system for converting network drawings from raster format to vector format, the system comprising:
a computer executable module for recognizing text within a raster image by using optical character recognition and a character set associated with the raster image, the raster image comprising a network drawing in raster format;
a computer executable module for extracting the recognized text to produce a text-only raster image and a text-stripped raster image;
a computer executable module for recognizing graphic objects within the text-stripped raster image by using pattern recognition and image-specific parameters associated with the raster image,
a computer executable module for using vector graphical primitives corresponding to the recognized graphic objects to produce a text-stripped vector image; and
a computer executable module for adding vector text elements corresponding to the extracted text into the text-stripped vector image to produce a vector image substantially identical in appearance to the raster image.

10. The system of claim 9, wherein the computer executable sub-module for recognizing graphic objects within the text-stripped raster image comprises a computer executable sub-module for recognizing less ambiguous graphic objects before recognizing more ambiguous graphic objects.

11. The system of claim 9, wherein the computer executable module for recognizing graphic objects within the text-stripped raster image comprises a computer executable sub-module for noise smoothing.

12. The system of claim 9, wherein the computer executable module for recognizing graphic objects within the text-stripped raster image comprises:
a computer executable sub-module for building a list of two-dimensional pixel runs;
a computer executable sub-module for recognizing lines from the list of two-dimensional pixel runs;
a computer executable sub-module for removing from the list of two-dimensional pixel runs the pixel runs recognized as lines;
a computer executable sub-module for recognizing binary large objects from the list of two-dimensional pixel runs; and
a computer executable sub-module for recognizing graphic objects from the recognized blobs by matching each binary large object with its corresponding vector graphical primitive.

13. The system of claim 12, wherein the computer executable sub-module for building a list of two-dimensional pixel runs comprises:
a computer executable sub-module for merging pixel runs having identical x-coordinates and adjacent y-coordinates to create two-dimensional pixel runs; and
a computer executable sub-module for removing the pixel runs merged with another pixel run from the list of two-dimensional pixel runs.

14. The system of claim 12, further comprising a computer executable module for repairing binary large objects split by pixel removal during line recognition.

15. The system of claim 9, further comprising a computer executable module for defining the image-specific parameters.

16. The system of claim 9, wherein the raster image comprises a wiring diagram in raster format.

17. A computer-readable medium interpretable by a computer, the computer-readable medium comprising:
instructions for causing the computer to recognize text within a raster image by using optical character recognition and a character set associated with the raster image, the raster image comprising a network drawing in raster format;
instructions for causing the computer to extract the recognized text to produce a text-only raster image and a text-stripped raster image;
instructions for causing the computer to recognize graphic objects within the text-stripped raster image by using pattern recognition and image-specific parameters associated with the raster image,
instructions for causing the computer to use vector graphical primitives corresponding to the recognized graphic objects to produce a text-stripped vector image; and
instructions for causing the computer to add vector text elements corresponding to the extracted text into the text-stripped vector image to produce a vector image substantially identical in appearance to the raster image.

18. The computer-readable medium of claim 17, further comprising instructions for causing the computer to recognize less ambiguous graphic objects before recognizing more ambiguous graphic objects.

19. The computer-readable medium of claim 17, further comprising instructions for causing the computer to smooth noise while recognizing graphic objects within the text-stripped raster image.

20. The computer-readable medium of claim 17, wherein the instructions for causing the computer to recognize graphic objects within the text-stripped raster image further comprises:
instructions for causing the computer to build a list of two-dimensional pixel runs;
instructions for causing the computer to recognize lines from the list of two-dimensional pixel runs;
instructions for causing the computer to remove from the list of two-dimensional pixel runs the pixel runs recognized as lines;
instructions for causing the computer to recognizing binary large objects from the list of two-dimensional pixel runs; and
instructions for causing the computer to recognizing graphic objects from the recognized binary large objects by matching each binary large object with its corresponding vector graphical primitive.

21. The computer-readable medium of claim 20, wherein the instructions for causing the computer to build a list of two-dimensional pixel runs further comprises:
instructions for causing the computer to merge pixel runs having identical x-coordinates and adjacent y-coordinates to create two-dimensional pixel runs; and
instructions for causing the computer to remove the pixel runs merged with another pixel run from the list of two-dimensional pixel runs.

22. The computer-readable medium of claim 20, further comprising instructions for causing the computer to repair binary large objects split by pixel removal during line recognition.

23. The computer-readable medium of claim 17, wherein the raster image comprises a wiring diagram in raster format.
